(19) United States
(12) Patent Application Publication
(10) Pub. No.: US 2017/0290305 A1
(43) Pub. Date: Oct. 12, 2017

(54) ANIMAL DRINKER AND DRIP CUP FOR AN ANIMAL DRINKER

(71) Applicant: Barnstorfer Kunststofftechnik GmbH & Co. KG, Barnstorf (DE)

(72) Inventor: Marko Rinnensland, Lohne (DE)

(73) Assignee: Barnstorfer Kunststofftechnik GmbH & Co. KG, Barnstorf (DE)

(21) Appl. No.: 15/471,799

(22) Filed: Mar. 28, 2017

(30) Foreign Application Priority Data
Apr. 8, 2016 (DE) 102016004076.9

(51) Int. Cl. A01K 39/02

(52) U.S. Cl. CPC A01K 39/02

(57) ABSTRACT

An animal drinker with a drip cup where the cup bodies are provided on the inside at least in part with a structuring. The structuring is created as a result of a coating of the inside surface of the cup body, as a result of which said inside surface is protected from damage caused by the sharp beaks of the animals. In addition, it is designed to provide the structuring with a roughened surface which serves as an abrasive material on which the animals are able to grind down their beaks. Animal drinkers have drip cups produced from plastics material. In the case of animal drinkers for poultry, the plastics material of the cup body is exposed to damage caused by the beaks of the poultry. Over and above this, poultry have to take care of their beaks regularly by grinding down their beaks.

### STATEMENT OF RELATED APPLICATIONS

This application claims the benefit of German Patent Application No. 10 2016 004 076.9 having a filing date of 8 Apr. 2016.

### BACKGROUND OF THE INVENTION

### Technical Field

The invention relates to a drip cup for an animal drinker for poultry, such as hens, ducks, turkeys, chickens, having a cup body which comprises an indentation for a water supply and at least one supporting arm for fastening the cup body on a water supply line, and to an animal drinker having at least one drip cup such as an animal drinker for poultry, such as hens, ducks or chickens, having a water supply line which has associated therewith at least one drinker valve, and in each case a drip cup, which is associated with the respective drinker valve, with a cup body produced from plastics material.

### Prior Art

Animal drinkers for beaked animals, in particular poultry, such as hens, turkeys, ducks, chickens or the like, have drip cups. The drip cups are conventionally associated with drinker valves which are connected to a strand-like water supply line, for example are screwed into the water supply line. The animals are able to actuate the drinker valves automatically in such a manner that they output water. Said water collects in trough-like cup bodies of the drip cups. The animals take the required water out of the cup bodies of the drip cups. In this connection, this water can be tap water, but also tap water with additives, for example medicines.

The drip cups, at least, however, their cup bodies, are conventionally produced from plastics material, for example from thermoplastic material. The animals, in particular when they are mature, can damage the plastics material of at least the cup bodies of the drip cups with their beaks, for example when they knock against the inside surfaces of the cup bodies with their beaks to take the water. The poultry then peck, as it were, the cup bodies with the beaks. This results over time in wear of at least the regions or portions of the cup bodies which are reachable by the beaks of the poultry.

The beaked animals, such as namely poultry, have to regularly wear away their beaks. In the case of conventional drip cups produced from plastics material, the animals are not able to wear away their beaks because said drip cups have smooth surfaces. In particular, the plastics material inside surfaces of the cup bodies of the drip cups which are particularly easy to reach by the beaks of the animals are relatively smooth.

### BRIEF SUMMARY OF THE INVENTION

The object underlying the invention is to create a drip cup and an animal drinker with at least one such drip cup which meet the needs of animals which have beaks, such as poultry, and/or are resistant to the beaks of poultry.

A drip cup for achieving the aforementioned object comprises a cup body which comprises an indentation for a water supply and at least one supporting arm for fastening the cup body on a water supply line, characterized in that at least a part region of an inside surface of the cup body is provided with a structuring. Accordingly, at least part of the inside surface of the cup body of the drip cup has associated therewith a structuring. The structuring bestows a rugged and/or irregular surface on the inside surface of the relevant cup body. The top of such a surface is rough. This makes it possible for the poultry to take care of, in particular to wear away, their beaks on the structuring of the cup bodies of the drip cups. As a result of the respective structuring being assigned to the cup bodies of the drip cups, the animals can do this in conjunction with taking-in the liquid. It is sufficient when only those regions of the inside surface of the cup bodies that are usually reachable by the beaks of the poultry, not only the mature poultry but also adolescent poultry and chicks, are structured or provided with a structuring. However, it is also conceivable to structure the entire inside surface of the cup bodies or to provide them with a continuous full-surface structuring.

In the case of a preferred design of the invention, it is designed to provide and/or to apply the structuring on an inside surface of the relevant cup body, preferably of the plastics material for the forming of the same.

In a preferred manner, the structuring is formed by a coating of at least part of the inside surface of the cup body of the respective drip cup. This can occur in different ways, for example as a result of painting, injecting or similar. As a result, the structuring can be applied retrospectively, that is to say after the production of the actual cup body or the actual drip cup, onto at least part of the inside surface of the respective cup body. The coating comprising and/or forming the structuring covers at least part of the cup body. The drip cup or at least the cup body can thus be produced in the conventional manner from plastics material, for example using the injection molding method. The structuring can then be applied afterwards in a targeted manner and above all from the provided material onto the inside surface of the cup body, over the entire surface or also only in regions.

A preferred option for forming the structuring of at least part of the inside surface of the respective cup body consists in an at least partial coating of the inside surface of the plastic material of the cup body. As a result of the at least partial coating, the desired structuring can be applied onto the plastics material of the cup body. In this case, the coating protects the plastics material of the cup body from damage caused by the beaks of the poultry.

In a preferred manner, the structuring is assigned to at least one such region of the cup body, preferably is applied to at least one such region of the cup body which is accessible by the poultry, in particular by their beaks. In a preferred manner, these are outer circumferential edge regions of the cup body. Said edge regions do not need to extend right up to the edge, they can also be at a small spacing from the edge.

In the case of an advantageous design of the drip cup, it is provided to realize the structuring as a roughening. As an alternative to this or in addition to it, it is conceivable to provide the structuring with at least one roughened surface. In a preferred manner, the roughening and/or the roughened surface are realized in a sandpaper-like or abrasive-paper-like manner. The roughening or roughened surface then acts as an abrasive material. In the case of such roughening or such a roughened surface, it is possible for the poultry, in conjunction with the water intake, both at the same time as drinking or beforehand and/or afterwards, to wear away their beaks on the roughening or rather on the roughened surface. The cup body of the drip cup then serves at the same time as abrasive material for the beaks of the animals, in a preferred manner hens, ducks, geese, turkeys as well as their chicks/offspring. The drip cup enables the beaked animals consequently not only to cover their water requirement, but the structuring also makes it possible for the animals to take care of their beaks.

According to an advantageous design of the roughening or rather of the roughened surface, it is provided that this comprises small grains produced from preferably mineral and/or ceramic material. The small grains can be formed, for example, from sand, ceramic, corundum, glass or the like. It is also conceivable to use synthetic material, for example hardened synthetic resin, to form the grains instead of mineral materials.

In a preferred manner, the grains of the named materials have a relatively small grain size within the range of between 20 μm and 1,000 μm, in particular between 200 μm and 800 μm. The grains of said size allow the animals to grind down their beaks easily and relatively smoothly without negatively influencing the beaks at the same time.

The small or rather fine grains preferably have an irregular shape or rather structure. In a preferred manner, the small and fine grains are formed irregularly in such a manner that they have small edges. Said edges can also be at least in part sharp edges. As a result, the structuring of the inside surface of the respective cup body has a top surface which is roughened in order to act abrasively in the manner of an abrasive surface.

In the case of a preferred design of the structuring of the drip cup, in particular of the inside surface of the cup body, it is provided to arrange the grains on the surface of a connecting layer on the inside surface of the respective cup body. As an alternative to this or in addition to it, it is also conceivable to embed the grains in part in the connecting layer in the cup body. The connecting layer thus forms an adhesive layer in order to fix the grains over the long term, preferably permanently, on the inside surface or at least a part region of the inside surface of the cup body. The connecting layer, in this case, serves not only to fix the grains on the inside surface of the cup body; the connecting layer also forms an additional protective layer for the inside surface of the cup body against damage caused by the beaks of the animals.

It is particularly advantageous when the connecting layer is formed from a resin layer, in particular a synthetic resin layer, or a layer of adhesive, which is applied onto the inside surface of the plastics material cup body in the region of the structuring and/or roughening. After hardening, the connecting layer then forms a particularly robust and preferably wear-resistant reinforcement of the inside surface of the cup body. Plastics material cup bodies, in particular, are made more robust and more wear-resistant against mechanical damage as a result of the connecting layer. As a result, the connecting layer serves as protection or additional protection against damage caused by the beaks of the animals for cup bodies formed from plastics material.

The invention is particularly suitable for drip cups which are produced entirely from plastics material, in particular are injected from thermoplastic material. However, the invention is also suitable for such drip cups where only the cup bodies are formed from plastics material, in particular from injected thermoplastic material.

An animal drinker for achieving the object named in the introduction is an animal drinker for poultry, such as hens, ducks or chickens, having a water supply line which has associated therewith at least one drinker valve, and in each case a drip cup, which is associated with the respective drinker valve, with a cup body produced from plastics material, characterized in that at least part of an inside surface of the respective cup body is provided with a structuring. In the case of said animal drinker, it is designed to provide at least part of an inside surface of a cup body of the drip cup with a structuring. The structuring can be realized and arranged precisely as has been described above in conjunction with the structuring of the drip cup. Reference is made hereto to avoid repetition. The same applies to the applying of the structuring onto the inside surface of the cup body, formed from plastics material, of all or selected drip cups of the animal drinker.

### BRIEF DESCRIPTION OF THE DRAWINGS

Preferred exemplary embodiments of the invention will be explained in more detail below by way of the drawing in which:

FIG. 1 shows a side view of part of an animal drinker with several drip cups,

FIG. 2 shows a perspective view of the drip cup of FIG. 1,

FIG. 3 shows a central vertical section through the drip cup of FIG. 2,

FIG. 4 shows a top view of the drip cup of FIGS. 2 and 3,

FIG. 5 shows a perspective view of a drip cup according to a second exemplary embodiment of the invention,

FIG. 6 shows a perspective view of a drip cup according to a third exemplary embodiment of the invention,

FIG. 7 shows a top view of the drip cup of FIG. 6,

FIG. 8 shows a perspective view of a drip cup according to a fourth exemplary embodiment of the invention and

FIG. 9 shows a vertical longitudinal section through the drip cup of FIG. 8.

### DETAILED DESCRIPTION OF PREFERRED EMBODIMENTS

The animal drinker shown is realized as a so-called strand drinker for the floor keeping of poultry. The animal drinker makes it possible for poultry of various ages, that is to say also chicks and broilers, to cover their water requirement themselves. Poultry, in a preferred manner, are hens, ducks, turkeys, geese or other beaked animals.

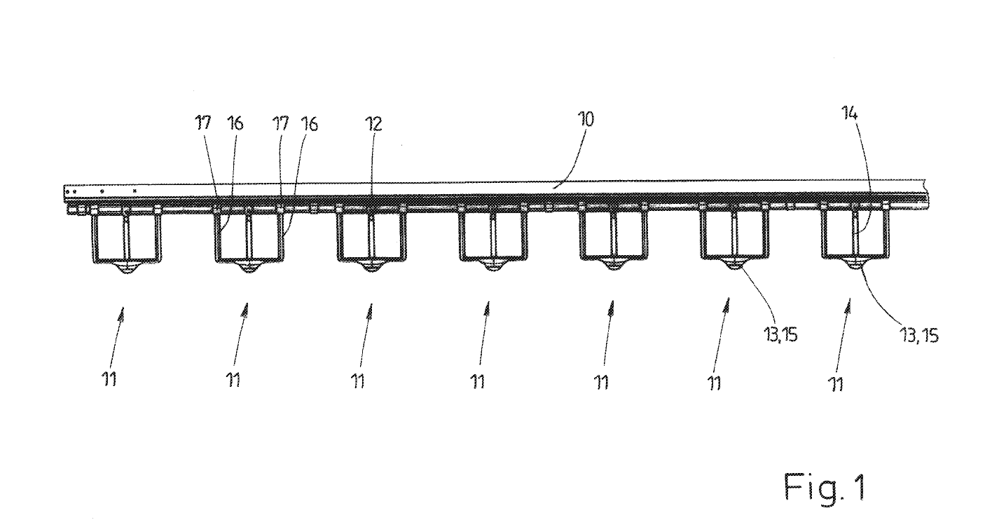

The animal drinker shown only in part in FIG. 1 has an elongated, tube-like water supply line 10 with several drinker points 11 that are spaced apart from one another. In the exemplary embodiment shown, all the drinker points 11 of the animal drinker are realized in an identical manner. The invention is also suitable, however, for animal drinkers with only one single drinker point.

Each drinker point 11 comprises substantially one drinker valve 12 and one drip cup 13. The respective drinker valve 12 is screwed or inserted into the water supply line 10 from below. The drinker valve 12, which is known per se, has a valve pin which projects out of the housing of the drinker valve 12 by way of a bottom, free actuating end. A bar-like/tube-like actuating means 14, which projects into the drip cup 13 by way of a bottom free end, is provided in the case of the animal drinker shown in FIG. 1. The actuating means 14 is pivotable about a horizontal rotational axis, which extends transversely to the longitudinal direction of the water supply line 10, the actuating end of the valve pin entrains the drinker valve and consequently also pivots to open the drinker valve 12.

The poultry are able to pivot the tube-like or bar-like actuating means 14 with their beaks and as a result open the drinker valve 12. As a result, water, which can be pure fresh water or also such with additives, for example medicines, supplied to the drinker valve 12 through the water supply line 10 can emerge at the bottom out of the drinker valve 12 and pass into the drip cup 13 along the outside of the bar-like actuating means 14 or inside through the tube-like actuating means 14. As a result of the actuating means 14 being released, the drinker valve 12 closes automatically, as a result of which further unwanted outflow of water or another liquid out of the drinker valve 12 is interrupted.

It is also conceivable for the animal drinker not to have any actuating means 14 assigned to the actuating end of the valve pin of the drinker valve 12. The actuating end of the valve pin is then directly actuated, namely pivoted and/or raised, by the beak of the respective animal in order to open the drinker valve 12. The drinker valve 12 is then automatically closed again when it is released.

The respective drip cup 13 has a cup body 15 which accommodates a supply of liquid and is provided with two parallel, upright supporting arms 16. The supporting arms 16 are connected to the cup body 15 in one piece at oppositely located end regions of the said cup body. A fastening means, which is realized as a clip closure 17 in the exemplary embodiment shown, is situated in each case on the top free ends of the supporting arms 16. The clip closure 17 is also integrally formed in one piece on the respective supporting arm 16. Each drip cup 13 is connected releasably to the water supply line 10 by way of the clip closures 17 on the top ends of the two parallel supporting arms 16.

The respective drip cup 13 is formed from plastics material and is preferably produced in one piece from plastics material, for example from thermoplastic material using the injection molding method.

The cup body 15 of the drip cup 13 shown has an elongated, boat-like shape. In cross section, the shape of the cup body 15 changes, and preferably continuously, from the deepest point 18 in the bottom region toward the top edge 19. A bottom part of the cup body 15 which proceeds from the deepest point 18 is provided with a circular cross section. Said circular cross section merges continuously toward the top edge 19 into an elliptical or oval cross section. In this case, the ratio between the longer axis and the shorter axis of the elliptical cross section of the top part of the cup body 15 increases toward the top edge 19. This means the elliptical cross sectional shape of the cup body 15 becomes continuously more marked toward the top edge 19. In the exemplary embodiment, the two parallel supporting arms 16 are integrally formed in one piece on oppositely situated regions of the edge 19 of the cup body 15 which lie on the large axis of the elliptical edge 19 of the cup body 15. In this way, the parallel, upright supporting arms 16 are situated in a vertical plane through the large axis of the elliptical edge 19 of the cup body 15. Due to the realization of the cup body 15, which changes to an elliptical shape toward the top, the water supply in the cup body 15 increases disproportionately as the water level rises.

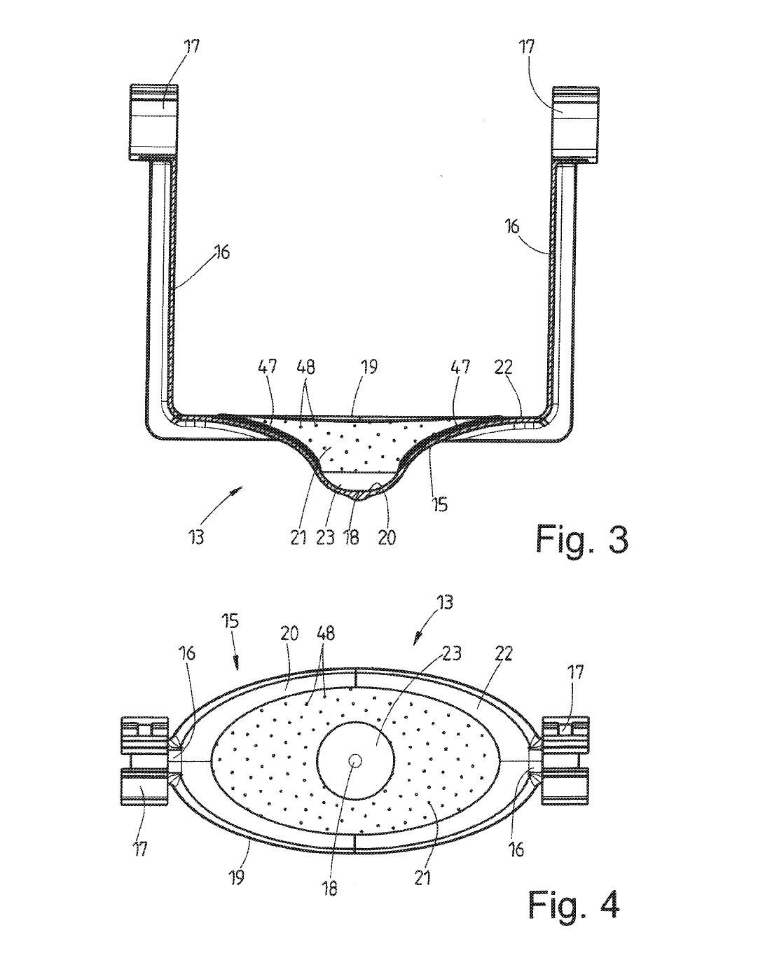

On account of the drip cup 13 being formed from plastics material, in particular as a result of injection molding, the walls of the drip cup 13 are relatively smooth. This also applies to the interior surface, namely inside surface 20, of the cup body 15. The invention is designed to provide the relatively smooth inside surface 20 of the cup body 15 at least in part with a structuring 21 and as a result to roughen it up. In the exemplary embodiment of FIGS. 1 to 4, the inside surface 20 of the cup body 15 is only provided in part with a structuring 21. A narrow, circumferential edge region 22, which proceeds from the outer edge 19 of the cup body 15, and a lower bottom region 23 of the inside surface 20 of the cup body 15 which proceeds from the deepest point 18 of the cup body 15 are exempt from the structuring 21. The edge region 22 and the lower bottom region 23 consequently do not need to comprise any structuring 21 because said regions of the cup body 15 are, as a rule, not contacted by the beaks of the animals.

The structuring 21 can have several purposes, to protect the plastics material of the cup body 15 from damage caused by the partially sharp beaks of the poultry and/or in order to make it possible for the animals to take care of their beaks by being able to wear away or grind down the beaks on the rough structuring 21.

The structuring 21 is applied onto the desired region or, where applicable, onto several separate regions of the inside surface 20 of the cup body 15 once the drip cup 13 has been produced. Said retrospective applying of the structuring 21 on the cup body 15 can be effected as a result of coating, painting, injecting or the like. It is also conceivable to apply the structuring 21 subsequently onto the inside surface 20 of the cup body 15 as a prefabricated layer and to connect it thereto, for example as a result of sealing and/or bonding. It is also conceivable to produce or rather to form the structuring 21 as a result of a subsequent process, a mechanical process and/or mechanical surface treatment. In said case, no additional materials or substances are necessary for the structuring 21.

The structuring 21 is preferably realized such that it is rugged on the surface and as a result in the region of the structuring 21 the inside surface 20 of the cup body 15 is rough or roughened. Such a structuring 21 with a rough surface can act like an abrasive material. The cup body 15, in the region of the structuring 21, then has a surface, which comes into contact with the beaks of the animals, which is roughened in the manner of sandpaper.

The structuring 21 which comprises a roughened surface can be formed by a type of sanding in the region of the structuring 21. Such sanding comes about from a thick covering produced from fine grains 48. The grains 48 can be such from ceramic or mineral material, for example sand, glass, corundum or the like. The small grains 48, however, can also be formed from a hardenable plastics material. The grains 48 preferably have an irregular shape, that is to say are not in the shape of a ball. For example, the grains 48 comprise such an irregular shape that they comprise edges and/or sharp edges.

The fine grains 48 comprise a grain size which results in the free surface of the structuring 21 which is accessible to the beaks of the animals forming an abrasive surface. Said abrasive surface can be formed by an irregular grid of closely spaced fine grains 48. The grain size of the fine grains 48 is within the range of between 1000 μm and 20 μm, preferably between 600 μm and 100 μm.

In the event of the structuring 21 being formed by a coating, which is effected in the region of the same, at least in part, on the inside surface 20 of the cup body 15, the structuring 21 comprises a connecting layer 47 which is covered with the grains to form the roughened, abrasive-material-like structuring 21. Said coating covers the inside surface 20 of the cup body 15 in the region of the structuring 21 and is permanently connected thereto preferably by means of the connecting layer 47. The connecting layer 47 serves for the permanent fixing of the grains 48 at least on the inside surface 20 of the cup body 15. To this end, the grains are embedded in part in the connecting layer or are bonded to the same resting on the connecting layer.

The connecting layer consists in a preferred manner of a hardenable material, for example a resin, in particular a synthetic resin, or the like. Such a connecting layer 47 is applied onto the inside surface 20 of the cup body 15 in the region of the structuring 21 in the liquid or soft state. Prior to the hardening of the connecting layer 47, it is provided on its surface with the grains 48, for example as a result of scattering them or applying them pneumatically by means of an air jet. In this case, the grains 48 are connected and preferably embedded in part into the not yet hardened connecting layer 47.

It is also conceivable for the grains 48, together with a not yet hardened, liquid, pasty and/or binder-containing resin, synthetic resin or the like, to be applied onto the cup body 15, onto the inside surface 20, namely interior surface, of the cup body 15, in the region of the provided structuring 21 as a result of injecting or painting. After hardening, a surface that is roughened in a structured manner is also created in this way in the region of the inside surface 20 of the cup body 15 which is provided with the structuring 21. In this case, the grains 48 can also still be surrounded, where applicable, entirely by the flowable binder and/or the connecting layer 47, after the hardening of the same but only with a thin film. Said thin film is removed after a short time by the beaks of the animals such that upper part regions of the grains 48 are then exposed and can serve as abrasive material for wearing away the beaks of the poultry.

Further characteristics of the structuring of the inside surface 20 of the cup body 15 are conceivable. For example, the entire inside surface 20 can be provided with a structuring. The structuring then originates directly from the edge 19 such that it only leaves part of the lower bottom region 23 free. However, the entire inside surface 20 of the cup body 15 can also be provided with a continuous structuring. It is finally also conceivable to provide several separate parts of the inside surface 20 of the cup body with individual non-contiguous structuring. Whilst the structuring 21 is circumferentially ring-shaped, it is conceivable to realize separate structuring with arbitrary geometric shapes. This can be effected in such a manner that all the separate structuring form a certain pattern or even lettering on the inside surface 20 of the cup body 15.

Finally, it is also conceivable to design the structuring as such in a different color to the drip cup 13. For example, a differently-colored surface of the respective structuring 21 can come about as a result of the grains 48 maintaining their natural color, for example dark grey, the material for forming the connecting layer 47 either being correspondingly colored or remaining natural. When then, for example, the drip cup 13 is formed from red plastics material, the inside surface 20 of the cup body 15 only comprises a red color in the region that is left free by the structuring 21, whilst the at least one region of the structuring 21 has the, for example, dark grey color on account of the grains 48 on the inside surface 20 of the cup body 15. The color of the structuring 21 can be changed, where required, by using grains 48 produced from other materials.

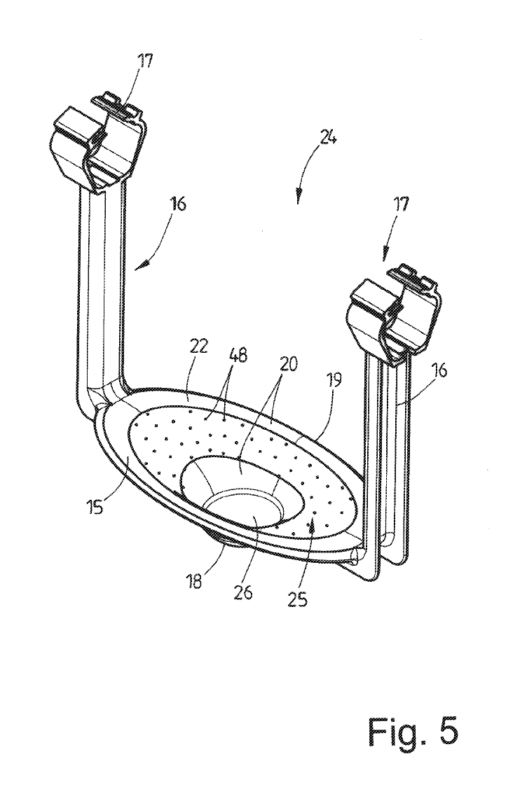

FIG. 5 shows a drip cup 24 according to a second exemplary embodiment of the invention. This corresponds to the drip cup 13 of FIGS. 1 to 4, which is why the same reference numerals have been used for the same parts.

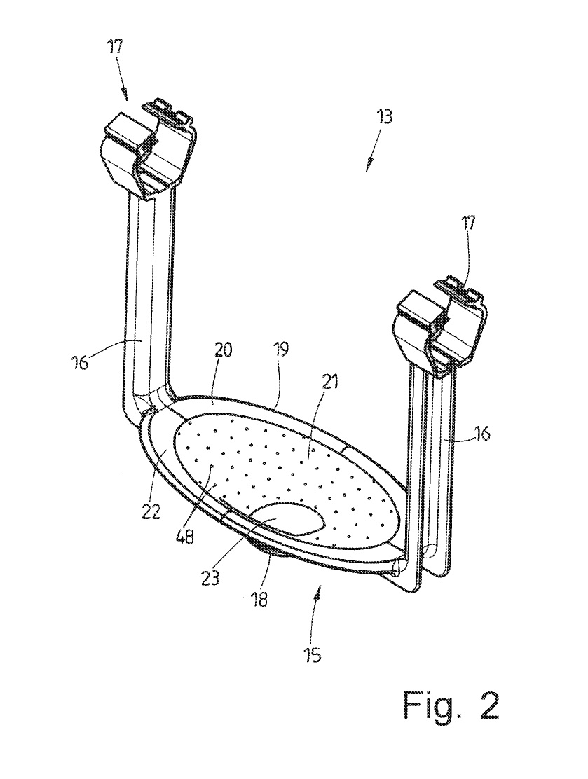

A difference between the drip cup 24 of FIG. 5 and the drip cup 13 of FIGS. 2 to 4 consists in that the structuring 25 extends over a smaller part of the inside surface 20 of the cup body 15. The structuring 25 is spaced from the oval edge 19 of the cup body 15 by an edge region 22 which is approximately the same width as in the case of the drip cup 13. Only the edge of the structuring 21 is further away from the deepest point 18 of the cup body 15 such that a larger lower bottom region 23 of the cup body 15 is left free by the structuring 21 and, as a result, said structuring extends over a smaller part of the inside surface 20 of the cup body 15.

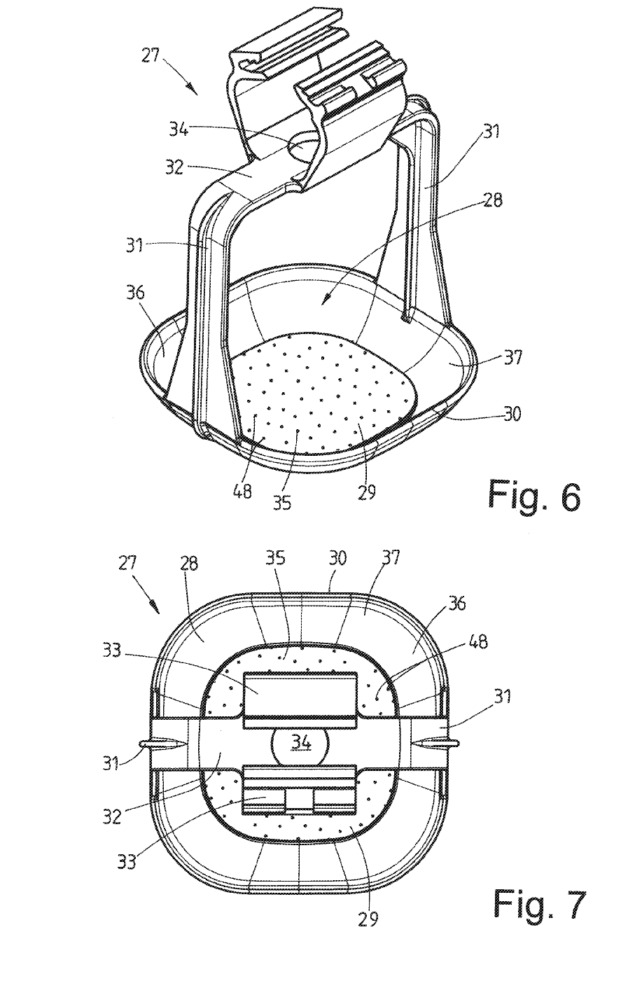

FIGS. 6 and 7 show a different exemplary embodiment of a drip cup 27 which is produced in one piece from plastics material. The drip cup 27 has a pan-like cup body 28 with a flat or only lightly domed bottom 29 which comprises a square bottom surface with strongly rounded corners. Accordingly, a circumferential, upright edge 30 of the cup body 28 also has a square shape with strongly rounded corners.

Two parallel upright supporting arms 31 are assigned to the drip cup 27 centrally at oppositely situated points of the wall 30. The top ends of the supporting arms 31, deviating from the previously described exemplary embodiments, are connected in one piece by a horizontal crosswise web 32, which extends at a parallel spacing above the bottom 29 of the cup body 28. In the case of said drip cup 27, a single clip closure 33 is integrally formed in one piece centrally above the web 32. The drip cup 27 is releasably fastenable to the water supply line 10 by way of the clip closure 33. The drinker valve 12, which is not shown in FIGS. 6 and 7, extends through a central through-bore 34 in the web 32.

The cup body 28 of the drip cup 27 is also provided with a structuring 35 which covers part of an inside surface 36 of the cup body 28. In the case of the exemplary embodiment of FIGS. 6 and 7, the structuring 35 is assigned to the bottom 29 of the cup body 28, such that it extends completely over the entire surface of the bottom 29. A circumferential, upright edge region 37 of the cup body 28 surrounding the bottom 29 is left free of the structuring 35 in the exemplary embodiment shown. Where applicable, however, the structuring 35 can also extend completely or in part over the edge region 37 of the cup body 28 which surrounds the bottom 29 all the way around.

The structuring 35 can be realized and applied onto the cup body 28 just as is described in conjunction with the structuring 21 and 25 of the drip cups 13 and 24. Reference is made thereto to avoid repetition.

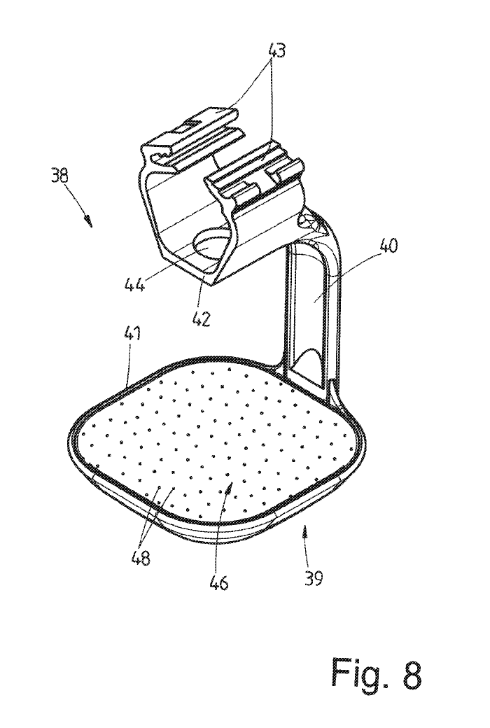

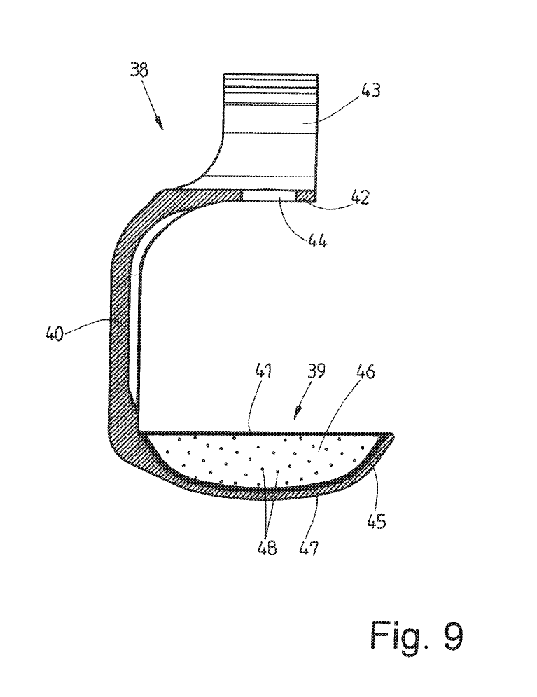

A further exemplary embodiment of a drip cup 38 which is formed in one piece from plastics material is shown in FIGS. 8 and 9. Said drip cup 38 has a cup body 39 which corresponds substantially to that of FIGS. 6 and 7. However, the drip cup 38 differs from the drip cup 27 of FIGS. 6 and 7 as a result of only one single supporting arm 40 being integrally molded in one piece to the top of the edge 41 of the cup body 39. A top end of the supporting arm 40 is bent off at right angles to an imaginary vertical longitudinal center axis through the cup body 39 to form a cantilever arm 42 which sticks out inwards in relation to the supporting arm 40. The cantilever arm 42 extends at a parallel spacing above the cup body 39 and ends somewhat behind the center of the cup body 39. A clip closure 43 is integrally formed in one piece onto the end region of the cantilever arm 42. In addition, the cantilever arm 42 has a through-bore 44 for a drinker valve 12 (not shown in FIGS. 8 and 9) in the region of the clip closure 43. Said through-bore 44 is located on the imaginary vertical longitudinal center axis of the cup body 39. The drip cup 38, suspended by its own supporting arm 40, is connected, also releasably, to the water supply line 10 (FIG. 1)—not shown in FIGS. 8 and 9—by way of the clip closure 43.

In the case of the drip cup 38 shown here, the entire inside surface 45 of the cup body 39 is provided with a structuring 46. Said structuring 46 can be realized as the structuring 21 of the drip cup 13 described in conjunction with the exemplary embodiment of FIGS. 1 to 4.

The structuring 46 is shown schematically in cross section in FIG. 9, the connecting layer 47 being shown as a thick line on the inside surface 45 of the cup body 39 and part of the very many grains 48 for forming the rugged, roughened and abrasive-material-like exposed surface of the structuring 46 being shown symbolically as a few dots. Said exposed surface of the structuring 46 and in particular its grains 48 located thereon are wettable by the liquid in the drip cup 38, namely in the cup body 39, and are accessible by the beaks of the poultry. The grains 48 of the structuring 21, 25 and 35 are also shown in FIGS. 2 to 7 in a symbolic manner.

A few drip cups and the complete or partial structuring of the inside surfaces of the cup bodies are shown as an example in the preceding description. The invention is also suitable for drip cups, in particular cup bodies, which are realized in an arbitrary other manner and have a different type and size of structuring, in particular a different base area.

### LIST OF REFERENCES

10 Water supply line
11 Drinker point
12 Drinker valve
13 Drip cup
14 Actuating means
15 Cup body
16 Supporting arm
17 Clip closure
18 Deepest point
19 Edge
20 Inside surface
21 Structuring
22 Edge region
23 Lower bottom region
24 Drip cup
25 Structuring
26 Lower bottom region
27 Drip cup
28 Cup body
29 Bottom
30 Edge
31 Supporting arm
32 Web
33 Clip closure
34 Through-bore
35 Structuring
36 Inside surface
37 Edge region
38 Drip cup
39 Cup body
40 Supporting arm
41 Edge
42 Cantilever arm
43 Clip closure
44 Through-bore
45 Inside surface
46 Structuring
47 Connecting layer
48 Grain

What is claimed is:

1. A drip cup for an animal drinker for poultry, such as hens, ducks, turkeys, chickens, having a cup body (15, 28, 39) which comprises an indentation for a water supply and at least one supporting arm (16, 31, 40) for fastening the cup body (15, 28, 39) on a water supply line (10), wherein at least a part region of an inside surface (20, 36, 45) of the cup body (15, 28, 39) is provided with a structuring (21, 25, 35, 46).

2. The drip cup according to claim 1, wherein the structuring (21, 25, 35, 46) is arranged on the inside surface (20, 36, 45) of the relevant cup body (15, 28, 39).

3. The drip cup according to claim 1, wherein the structuring (21, 25, 35, 46) covers the inside surface (20, 36, 45) of the cup body (15, 28, 39) at least in part.

4. The drip cup according to claim 1, wherein the structuring (21, 25, 35, 46) is realized as an at least partial coating of the inside surface (20, 36, 45) of the relevant cup body (15, 28, 39).

5. The drip cup according to claim 4, wherein the coating forming the structuring (21, 25, 35, 46) is realized with at least two layers.

6. The drip cup according to claim 1, wherein the structuring (21, 25, 35, 46) is applied on at least one such region of the cup body (15, 28, 39) which is accessible by the beaks of the poultry.

7. The drip cup according to claim 1, wherein the structuring (21, 25, 35, 46) forms an abrasive surface.

8. The drip cup according to claim 1, wherein the structuring (21, 25, 35, 46) is realized in the manner of an abrasive material.

9. The drip cup according to claim 1, wherein the structuring (21, 25, 35, 46) comprises a roughened surface.

10. The drip cup according to claim 9, wherein the roughened surface of the structuring is realized in the manner of an abrasive material.

11. The drip cup according to claim 1, wherein the structuring (21, 25, 35, 46) comprises small grains (48).

12. The drip cup according to claim 11, wherein the small grains (48) comprise an irregular structure.

13. The drip cup according to claim 11, wherein the grains (48) of the structuring (21, 25, 35, 46) are arranged on the surface of a connecting layer (47) provided on the inside surface (20, 36, 45) of the cup body (15, 28, 39).

14. The drip cup according to claim 11, wherein the grains (48) of the structuring (21, 25, 35, 46) are embedded in part in the connecting layer (47).

15. The drip cup according to claim 14, wherein the connecting layer (47) is realized as a layer with adhesion properties applied on the inside surface (20, 36, 45) of the cup body (15, 28, 39) in the region of the structuring (21, 25, 35).

16. The drip cup according to claim 1, wherein at least the cup body (15, 28, 39) is formed from plastic material.

17. An animal drinker for poultry, such as hens, ducks or chickens, having a water supply line (10) which has associated therewith at least one drinker valve (12), and in each case a drip cup (13, 24, 27, 38), which is associated with the respective drinker valve (12), with a cup body (15, 28, 39) produced from plastics material, wherein at least part of an inside surface (20, 36, 45) of the respective cup body (15, 28, 39) is provided with a structuring (21, 25, 35, 46).

18. The animal drinker according to claim 17, wherein the structuring (21, 25, 35, 46) is realized as an at least partial coating of the inside surface (20, 36, 45) of the relevant cup body (15, 28, 39).

19. The animal drinker according to claim 17, wherein the structuring (12, 25, 35, 46) is applied on at least one such region of the cup body (15, 28, 39) which is accessible by the beaks of the poultry.

20. The animal drinker according to claim 17, wherein the structuring (21, 25, 35, 46) forms an abrasive surface.

21. The animal drinker according to claim 17, wherein the structuring (21, 25, 35, 46) comprises a roughened surface.

22. The animal drinker according to claim 17, wherein the structuring (21, 25, 35, 46) comprises small grains (48).

23. The animal drinker according to claim 22, wherein the grains (48) of the structuring (21, 25, 35, 46) are arranged on the surface of a connecting layer (47) which is provided on the inside surface (20, 36, 45) of the cup body (15, 28, 39).
